(19) United States
(12) Patent Application Publication
(10) Pub. No.: US 2013/0132293 A1
(43) Pub. Date: May 23, 2013

(54) SYSTEM AND METHOD FOR MATCHING AGENTS OR ADVISORS WITH POTENTIAL CLIENTS

(71) Applicants: Peter Sterczyk, Nanaimo (CA); Tim Sterczyk, Ottawa (CA); Susan Sterczyk, Ottawa (CA)

(72) Inventors: Peter Sterczyk, Nanaimo (CA); Tim Sterczyk, Ottawa (CA); Susan Sterczyk, Ottawa (CA)

(21) Appl. No.: 13/679,675

(22) Filed: Nov. 16, 2012

Related U.S. Application Data
(60) Provisional application No. 61/561,340, filed on Nov. 18, 2011.

(51) Int. Cl. G06Q 50/00; G06Q 50/16

(52) U.S. Cl. CPC G06Q 50/01; G06Q 50/16
USPC 705/319

(57) ABSTRACT

A web-based system and method for matching potential clients with agents and/or advisors using personality compatibility ranking. The method including preselecting agents based on geographic location and determining compatibility primarily based on guardedness. The method including steps for resolving ranking ties.

This application claims the benefit of U.S. Provisional Application No. 61/561,340, filed 18 Nov. 2011.

### FIELD OF THE INVENTION

The present invention relates to a web-based system and method for matching agents or advisors with potential clients.

### BACKGROUND OF THE INVENTION

In many aspects of life, individuals require the assistance of agents or professional advisors. For example, purchasers and sellers of real estate typically retain: real estate agents to assist in finding suitable properties and/or buyers; mortgage brokers to assist in obtaining financing; and, in many jurisdictions, lawyers to assist in the property transfer.

Agent referral websites and web-based services are well known. For example, there are many websites providing lists of real estate agents sorted by geographic location.

### SUMMARY OF THE INVENTION

In one aspect, the present invention provides a web-based system for matching potential clients with agents or advisors based on compatibility rankings derived from personality profiles. The system preferably includes guided initial introduction procedures.

In another aspect the present invention provides a web-based method for matching agents or advisors with potential clients, implemented via a programmable computer or plurality of programmable computers connected to the internet and configured to present a website and perform the processes required to perform the following steps: collecting and storing business, contact and personality profile information from a plurality of agents or advisors; collecting and storing contact and personality profile information from potential clients; on receiving a request for agent compatibility information from a potential client, ranking the agents or advisors in terms of personality compatibility with the potential client; presenting compatibility information and partial identity information about one or more agents or advisors to the potential client; on receiving a request for agent contact from a potential client, notifying an agent or advisor selected by the potential client from the presented agents or advisors, of the agent's or advisor's selection; and on receiving an acceptance response from the agent or advisor selected by the potential client, providing the potential client and the selected agent or advisor with each other's contact information.

The agents or advisors may be real estate agents and the method may include the step of pre-selecting agents satisfying a geographic preference, prior to the step of ranking the agents or advisors in terms of personality compatibility with the potential client.

The step of ranking the agents or advisors in terms of personality compatibility with the potential client, may include determining the guardedness of the client and the agents or advisors, and identifying the agents or advisors who have the same guardedness as the client as preferred and the agents or advisors who do not share the same guardedness as the client as non-preferred. The step of ranking the agents or advisors in terms of personality compatibility with the potential client, may include determining a 3-dimensional vector based on scores for directness, guardedness, and right brained, for each of the client and the preferred agents or advisors; determining the magnitude of the difference between the 3-dimensional vectors for the client and the preferred agents or advisors; and ranking each of the preferred agents or advisors in terms of compatibility with the client based on the magnitude of the difference between the 3-dimensional vectors wherein the smaller the difference the higher the compatibility ranking.

The method may also include determining whether ranking each of the preferred agents or advisors in terms of compatibility with the client based on the magnitude of the difference between the 3-dimensional vectors has produced a tie, that is, an equal ranking for any preferred agents or advisors; and, if there is a tie: determining a 6-dimensional vector based on scores for risk taking, thriftiness, artistic/imaginative, optimism, night person and absent mindedness, for each of the client and the tied preferred agents or advisors; determining the magnitude of the difference between the 6-dimensional vectors for the client and the tied preferred agents or advisors; and ranking each of the tied preferred agents or advisors relative to each other in terms of compatibility with the client based on the magnitude of the difference between the 6-dimensional vectors wherein the smaller the difference the higher the compatibility ranking.

The method may also include determining whether the ranking of each of the tied agents or advisors relative to each other in terms of compatibility with the client based on the magnitude of the difference between the 6-dimensional vectors has eliminated all ties; and, if not, determining the duration of time since each of the tied preferred agents or advisors provided the agent's or advisor's personality profile information; and ranking each of the tied agents or advisors relative to each other in terms of the duration of time wherein the greater the duration of time, the higher the ranking.

The method may also include determining whether the ranking of each of the tied agents or advisors relative to each other in terms the duration of time since each of the tied preferred agents or advisors provided the agent's or advisor's personality profile information has eliminated all ties; and, if not, determining a response time value for the tied preferred agents or advisors, and ranking each of the tied agents or advisors relative to each other in terms of their response time values wherein the smaller the response time values the higher the ranking.

The method may also include determining whether the ranking of each of the tied agents or advisors relative to each other in terms of compatibility with the client based on the magnitude of the difference between the 6-dimensional vectors has eliminated all ties; and, if not, determining a response time value for the tied preferred agents or advisors, and ranking each of the tied agents or advisors relative to each other in terms of their response time values wherein the smaller the response time values the higher the ranking.

The method may also include determining whether there are three or more preferred agents or advisors; and if not, determining a 3-dimensional vector based on scores for directness, guardedness, and right brained, for each of the non-preferred agents or advisors; determining the magnitude of the difference between the 3-dimensional vectors for the client and the non-preferred agents or advisors; and ranking each of the non-preferred agents or advisors in terms of compatibility with the client based on the magnitude of the difference between the 3-dimensional vectors wherein the smaller the difference the higher the compatibility ranking, and wherein all non-preferred agents or advisors are ranked below any preferred agents or advisors.

The method may also include determining whether ranking each of the non-preferred agents or advisors in terms of compatibility with the client based on the magnitude of the difference between the 3-dimensional vectors has produced a tie, that is, an equal ranking for any non-preferred agents or advisors; and, if there is a tie: determining a 6-dimensional vector based on scores for risk taking, thriftiness, artistic/imaginative, optimism, night person and absent mindedness, for each of the tied non-preferred agents or advisors; determining the magnitude of the difference between the 6-dimensional vectors for the client and the tied non-preferred agents or advisors; and ranking each of the tied non-preferred agents or advisors relative to each other in terms of compatibility with the client based on the magnitude of the difference between the 6-dimensional vectors wherein the smaller the difference the higher the compatibility ranking.

Presenting compatibility information and partial identity information about one or more agents or advisors to the potential client, may include presenting, for each of said agents or advisors, a compatibility ranking, a photograph and a first name.

Notifying an agent or advisor selected by the potential client from the presented agents or advisors, of the agent's or advisor's selection, may include sending a selection email to the agent or advisor. The method may also include determining whether receiving an acceptance response from the agent or advisor occurs within 12 hours of sending a selection e-mail to the agent or advisor; and, if not, sending a reminder email to the agent or advisor. The method may also include determining whether receiving an acceptance response from the agent or advisor occurs within 24 hours of sending a selection e-mail to the agent or advisor; and, if not, recording a status of dormant for the agent or advisor; sending a dormant-notification email to the agent or advisor notifying the agent or advisor of the dormant status; and sending an email to the potential client inviting the potential client to select another agent or advisor.

In another aspect, the present invention provides a web-based method for matching real estate agents with potential clients, implemented via a programmable computer or plurality of programmable computers connected to the internet and configured to present a website and perform the processes required to perform the following steps:

collecting and storing business, contact and personality profile information from a plurality of real estate agents;

collecting and storing contact and personality profile information from potential clients;

on receiving a request for agent compatibility information from a potential client: pre-selecting agents satisfying a geographic preference and then ranking the pre-selected agents in terms of personality compatibility with the potential client, wherein the ranking comprises:
determining the guardedness of the client and the agents, and identifying the agents who have the same guardedness as the client as preferred and the agents who do not share the same guardedness as the client as non-preferred;
   determining a 3-dimensional vector based on scores for directness, guardedness, and right brained, for each of the client and the preferred agents, determining the magnitude of the difference between the 3-dimensional vectors for the client and the preferred agents, ranking each of the preferred agents in terms of compatibility with the client based on the magnitude of the difference between the 3-dimensional vectors wherein the smaller the difference the higher the compatibility ranking
   determining whether ranking each of the preferred agents in terms of compatibility with the client based on the magnitude of the difference between the 3-dimensional vectors has produced a tie, that is, an equal ranking for any preferred agents, and, if there is a tie: determining a 6-dimensional vector based on scores for risk taking, thriftiness, artistic/imaginative, optimism, night person and absent mindedness, for each of the client and the tied preferred agents; determining the magnitude of the difference between the 6-dimensional vectors for the client and the tied preferred agents; and ranking each of the tied preferred agents relative to each other in terms of compatibility with the client based on the magnitude of the difference between the 6-dimensional vectors wherein the smaller the difference the higher the compatibility ranking;
   determining a 3-dimensional vector based on scores for directness, guardedness, and right brained, for each of the client and the non-preferred agents, determining the magnitude of the difference between the 3-dimensional vectors for the client and the non-preferred agents, ranking each of the non-preferred agents in terms of compatibility with the client based on the magnitude of the difference between the 3-dimensional vectors wherein the smaller the difference the higher the compatibility ranking
   determining whether ranking each of the non-preferred agents in terms of compatibility with the client based on the magnitude of the difference between the 3-dimensional vectors has produced a tie, that is, an equal ranking for any non-preferred agents, and, if there is a tie: determining a 6-dimensional vector based on scores for risk taking, thriftiness, artistic/imaginative, optimism, night person and absent mindedness, for each of the client and the tied non-preferred agents; determining the magnitude of the difference between the 6-dimensional vectors for the client and the tied non-preferred agents; and ranking each of the tied non-preferred agents relative to each other in terms of compatibility with the client based on the magnitude of the difference between the 6-dimensional vectors wherein the smaller the difference the higher the compatibility ranking;
combining the ranked preferred agents and ranked non-preferred agents into a single ranked list in which all of the preferred agents are ranked higher than any of the non-preferred agents;

determining whether there are three or more agents in the single ranked list, and, if so, presenting compatibility information and partial identity information for the three top-ranked agents to the potential client;

on receiving a request for agent contact from a potential client, notifying an agent selected by the potential client from the presented agents, of the agent's selection; and

on receiving an acceptance response from the agent selected by the potential client, providing the potential client and the selected agent with each other's contact information.

### BRIEF DESCRIPTION OF DRAWINGS

FIG. 1 is a schematic flowchart representation of steps related to an agent signing up.

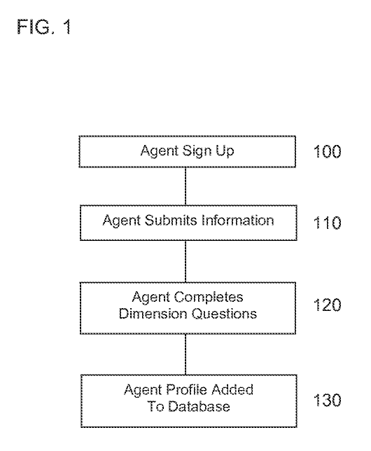

FIG. 2 is a schematic flowchart representation of steps related to an client signing up for the agent selection process.

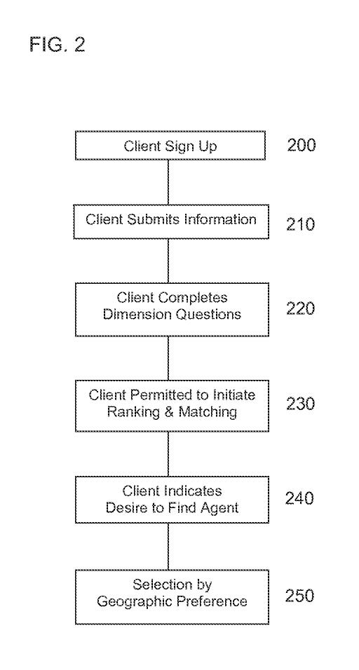

FIG. 3 is a schematic flowchart representation of steps related to the sorting and display of agents.

FIG. 4 is a schematic flowchart representation of steps related to an alternative approach to the sorting and display of agents.

FIG. 5 is a schematic flowchart representation of steps related to a refined sort, being a subset of the steps shown in FIG. 4.

FIG. 6 is a schematic flowchart representation of steps related to a client-initiated agent contact.

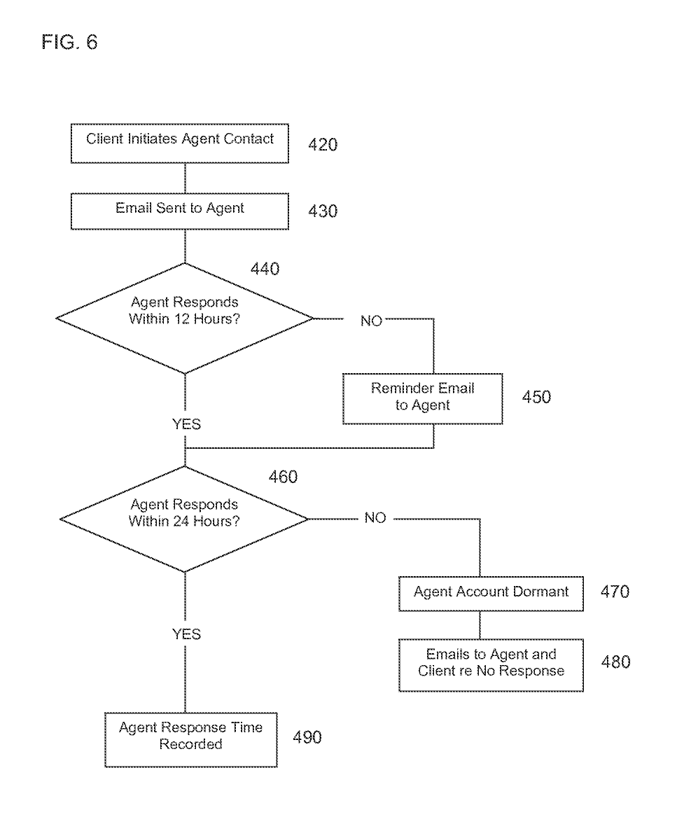

FIG. 7 is a schematic flowchart representation of steps related to an agent response to contact.

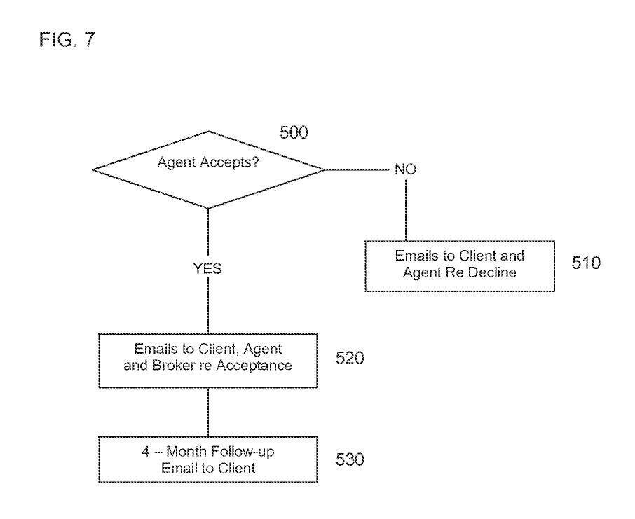

### DETAILED DESCRIPTION OF AN EMBODIMENT

The present invention, which has application with respect to many client—agent/advisor relationships is described herein with respect to an exemplary embodiment, being a system for matching potential clients and real estate agents.

A home purchase or sale is for many individuals the most significant financial transaction they will every make, and homes are not like other property, in that homes, and transactions involving them, often have a significant emotional weight. As a result, for many, the process of selling or buying a home is stressful.

Most sellers and buyers of homes retain the services of a real estate agent to assist with finding potential buyers and/or suitable properties. Typically, after a very short acquaintance (perhaps only one meeting) the client gives the real estate agent (often via a binding legal contract) a period of exclusivity with respect to any agency fees for the sale or purchase.

With a home purchase, the client relies on the agent to winnow out unsuitable properties and to direct the client to properties the are likely to satisfy the client's expressed desires, but also guide the client with respect to considerations about which the client (particularly if the client is a first-time home buyer) may not be aware. As well, the client and agent may spend a lot of time in each other's company as they evaluate possible properties. Thus, the client-agent relationship works best in terms of both the provision of the agent's services and the personal relationship between the agent and client, if the agent and client have compatible personality traits.

In one embodiment, the present invention involves a web-based system for matching real estate agents and clients and initiating contact between them. The system and components of same are at times referred to herein as the ranking and matching system, or merely as the matching system.

The matching system Home Page, preferably includes access portals for clients and agents, and is for example configured along the lines of the following:
Find A Real Estate Agent You'll Love Working With
   Client Login
      username
      password
      Not a member yet? Sign up here. (100)
Receive Clients You'll Love Working With
   Agent Login
      username
      password
      Not a member yet? Sign up here. (200)

The Client Account Set Up Page (i.e., the page linked from the Client—Not a member yet? Sign up here link) is preferably configured generally as follows for the purpose of colleting the information (210) indicated:
Client Account Set Up Page:
   First name
   Last name
   Address 1
   Address 2
   City
   Postal Code
   Primary phone
   email address (also username)
   Confirm email address
   Password (password rules)
   Confirm password
   “check box” to have read and accepted user agreement
   links to user agreement and privacy policy
   submit

The Agent Account Set Up Page (i.e., the page linked from the Agent—Not a member yet? Sign up here link) is preferably configured generally as follows for the purpose of collecting the information (110) indicated:
Agent Account Set Up Page:
   First Name
   Last Name
   Primary Phone
   Mobile Phone
   email address (also username)
   Confirm email address
   Password (password rules)
   Confirm password
   Select Province/Territory you're currently licensed to work in (from drop down list)
   Select primary city (from drop down list or auto complete)
   Select secondary city (from drop down list or auto complete)
   photo upload browse from file
   Brokerage name
   Brokerage address 1
   Brokerage address 2
   City
   Postal Code
   Brokerage Office Phone Number
   Broker's First Name
   Broker's Last Name
   Broker's email address
   Confirm Broker's email address
   “check box” to have read and accepted terms and conditions
   links to terms and conditions and privacy policy
   Submit

Once a client or agent has completed the sign-up requirements and has thus become a matching system member, he or she is directed to the Dimension Pages, which are the same for both clients and agents, and are preferably configured generally as follows, for the purpose of collecting the information outlined in greater detail in the following paragraphs
Dimension 1 Page
   A or B Matching Statements
   Submit
Dimension 2 Page
   ABC Multiple Choice Matching Statements
   Submit
Dimension 3 Page
   Scale of 1-5 Agree/Disagree Matching Statements
   Submit

The matching system uses a series of statements and questions to determine the personality traits of a person. The system measures nine different personality traits: directness, guardedness, right brained, risk taking, thriftiness, artistic/imaginative, optimism, night person, and absent mindedness.

The statements & questions themselves are grouped into three overall styles, or “Dimensions”. In the exemplary matching system implementation described herein, each Dimension is presented as a separate form or page.

For the highest matching accuracy, all statements/questions in all Dimensions should be answered (especially for agents).

Dimension 1: Dimension 1 consists of opposing statements. In the exemplary implementation described herein, the individual is presented with 22 pairs of opposing statements, and from each pair is asked to select the statement that best describes him or her. The Dimension 1 statements, and which of the nine personality traits they measure, are detailed below. Different implementations of the matching system may present the statements in a different format than shown below. For example, the order of the statements may be randomized, and the numerals preceding the statements would be omitted.

For the following statements, a response of 1 indicates directness; a response of 2 indicates the opposite of directness.
1 My response to change or risk is animated or random.
2 When confronted with change or risk, my reaction is guarded or foreseeable.
1 I shoot from the hip and respond instantaneously.
2 I am thoughtful and introspective with my reactions.
1 I thrive when I am the center of attention.
2 I do not like to draw attention to myself.
1 On the weekends, I like to plan activities with other people.
2 On the weekends, I prefer to stay at home and enjoy quiet time.
1 I enjoy new experiences.
2 I am more comfortable with familiar situations.
1 I need to have my opinion heard, even if it means interrupting someone else.
2 I can wait until the other person is finished speaking before I say anything.
1 I make strong assertions and assert my opinions freely.
2 I prefer to ask questions and keep my opinions to myself.
1 At social events, I often introduce myself.
2 At social events, I wait for others to introduce themselves.
1 Swift and direct action is my comeback for conflict.
2 When confronted by antagonism, I reply in a cautioned and indirect approach.
1 I frequently speak up during group discussions.
2 I do not regularly provide input to group discussions.
1 I can start a conversation with anyone.
2 I am usually quiet around strangers.

For the following statements, a response of 1 indicates guardedness; a response of 2 indicates the opposite of guardedness.
1 My hands are still when I am talking.
2 I talk with my hands.
1 My best work happens when I operate solo.
2 I thrive when I work with others.
1 My day regularly conforms to a schedule.
2 I like my day to be open for any possibility.
1 I am hesitant to get to know people and develop new relationships.
2 I welcome the opportunity to get to know people and develop new relationships.
1 I shine the spotlight on ideas, approaches, and the finished product.
2 My focus is people, connections, and feelings.
1 I keep my thoughts and feelings to myself.
2 I am comfortable sharing my feelings with others.
1 Data and facts are the basis of my decisions.
2 Relationships and feelings form the backbone of my decisions.
1 I am detail oriented.
2 I often forget to put things back in their place.
1 If someone was visibly upset during a meeting I was running, I would say nothing and continue with the meeting.
2 If someone was visibly upset during a meeting I was running, I would call for a break and take them aside to comfort them.
1 My conversations are centered on tasks.
2 I tell stories during conversations.
1 I am hesitant to receive input or opinions from others.
2 I readily welcome others' perspectives or positions.

Dimension 2: Dimension 2 consists of questions with multiple choice answers. In the exemplary implementation described herein, the individual is presented with 22 questions and for each question is asked to select the answer that best describes him or her. The Dimension 2 questions, and which of the nine personality traits they measure, are detailed below. Different implementations of the matching system may present the questions in a different format than shown below. For example, the order of the questions may be randomized, the order of the multiple choice selections may be randomized for each question, and the numerals preceding the multiple choice selections would be omitted.

For the following questions, a response of 1 indicates artistic/imaginative; a response of 3 indicates the opposite of artistic/imaginative; a response of 2 is neutral.
Which word best describes you?
1 playful
2 energetic
3 unpretentious
Which type of book would you prefer to read?
1 a mystery novel
2 a reference book
3 a memoir or biography
Do you ever doodle?
1 all the time
2 occasionally
3 never
What do you think of modern art?
1 modern art is visionary
2 I am sometimes interested by modern art
3 I don't like modern art
Which of the following would be most likely to cause you to have a sleepless night?
1 my mind can't stop
2 I am worrying about something
3 I am just not tired

For the following question, a response of 1 indicates thriftiness; a response of 3 indicates the opposite of thriftiness; a response of 2 is neutral.
Do you throw away the toothpaste when it's nearing the end of the tube?
1 no, I squeeze out the last drop
2 don't know
3 yes, I hate working for my toothpaste

For the following questions, a response of 1 indicates optimism; a response of 3 indicates the opposite of optimism; a response of 2 is neutral.
How much of a part do you think luck plays in one's life?
1 to a great extent you make your own luck
2 some people are luckier than others
3 a great deal
Which of the following most accurately describes your impressions of the fall season?
1 it is a beautiful, colorful time of the year
2 no strong feelings, it's just another time of the year
3 depressed that winter is just around the corner
How do you feel when you return from a fun vacation?
1 refreshed and anxious to reconnect with family and friends back home
2 excited to plan my next vacation
3 sad that it's over
If someone said to you ‘life is not a rehearsal’, how would that make you feel?
1 I′m doing the best with what I′ve got
2 I don't agree, there is something better after this life
3 I could have really used a rehearsal to make it better

For the following questions, a response of 1 indicates night person; a response of 3 indicates the opposite of night person; a response of 2 is neutral.
You are going out for an evening meal with friends. When would you prefer to book the meal?
1 after 9 p.m.
2 between 8 p.m. and 9 p.m.
3 before 8 p.m.
You are given a gift card for a clothing store. What would you choose to buy for yourself?
1 evening wear
2 sports clothes/active wear
3 some new work clothes
Which of the following colors do you prefer?
1 blue
2 yellow
3 pink
When do you find a big city to be most appealing?
1 after dark, when it's quiet and peaceful
2 during the day, when it is bustling with people
3 early morning, with few people around

For the following questions, a response of 1 indicates right brained; a response of 3 indicates the opposite of right brained; a response of 2 is neutral.
Which topic do you prefer to hear about on the news?
1 global and environmental issues
2 sports
3 politics
Which of the following statements best describes you?
1 I make my own rules
2 I follow rules and regulations only when it suits me
3 I always follow rules and regulations
Do you remember people primarily by their names or their faces?
1 I remember faces the best
2 I remember both equally
3 I remember names the best
Which of these words best describes you?
1 perceptive
2 efficient
3 thoughtful
When you attend an event without reserved seating and there are seats available on either side, which side do you normally prefer?
1 I sit on the left side
2 I have no preference
3 I sit on the right side
What was your favorite subject at school?
1 art
2 geography
3 mathematics

For the following questions, a response of 1 indicates risk taking; a response of 3 indicates the opposite of risk taking; a response of 2 is neutral.
Which description of you would secretly please you most?
1 untamed and brazen
2 astute and reliable
3 consistent and loyal
Given the choice, would you walk through a cemetery at night, or avoid it altogether?
1 I would love the graveyard
2 I don't know/maybe
3 never in a million years

Dimension 3: Dimension 3 consists of agreement/disagreement statements. In the exemplary implementation described herein, the individual is presented with 16 statements, and is asked how strongly he or she agrees or disagrees with each statement. The Dimension 3 statements, and which of the nine personality traits they measure, are detailed below. Different implementations of the matching system may present the statements in a different format than shown below. For example, the order of statements may be randomized, the order of the agree/disagree selections may be randomized for each question, the numerals preceding the agree/disagree selections would be omitted, or the agree/disagree selections may be presented in the form of a slider or as a series of radio buttons to indicate “range of agreement” from “strongly agree” to “strongly disagree”.

For the following statements, a response of 1 indicates artistic/imaginative; a response of 2 indicates artistic/imaginative (not as strongly); a response of 5 indicates the opposite of artistic/imaginative; a response of 4 indicates the opposite of artistic/imaginative (not as strongly); a response of 3 is neutral.
I travel to places for the scenery.
1 strongly agree
2 agree
3 neither agree nor disagree
4 disagree
5 strongly disagree
I like to visit art galleries.
1 strongly agree
2 agree
3 neither agree nor disagree
4 disagree
5 strongly disagree
I like to dabble on computers.
1 strongly agree
2 agree
3 neither agree nor disagree
4 disagree
5 strongly disagree
I have attended an art class.
1 strongly agree
2 agree
3 neither agree nor disagree
4 disagree
5 strongly disagree

For the following statements, a response of 1 indicates absent-mindedness; a response of 2 indicates absent-mindedness (not as strongly); a response of 5 indicates the opposite of absent-mindedness; a response of 4 indicates the opposite of absent-mindedness (not as strongly); a response of 3 is neutral.
I confuse people's names.
1 strongly agree
2 agree
3 neither agree nor disagree
4 disagree
5 strongly disagree
I can easily recall phone numbers.
1 strongly disagree
2 disagree
3 neither agree nor disagree
4 agree
5 strongly agree
I sometimes wear mismatched socks.
1 strongly agree
2 agree
3 neither agree nor disagree
4 disagree
5 strongly disagree
I make a point of noting everybody's birthday.
1 strongly disagree
2 disagree
3 neither agree nor disagree
4 agree
5 strongly agree

For the following statements, a response of 1 indicates risk taking; a response of 2 indicates risk taking (not as strongly); a response of 5 indicates the opposite of risk taking; a response of 4 indicates the opposite of risk taking (not as strongly); a response of 3 is neutral.
I would never want to jump out of an airplane with a parachute.
1 strongly disagree
2 disagree
3 neither agree nor disagree
4 agree
5 strongly agree
I like scary movies.
1 strongly agree
2 agree
3 neither agree nor disagree
4 disagree
5 strongly disagree
I would like to go scuba diving.
1 strongly agree
2 agree
3 neither agree nor disagree
4 disagree
5 strongly disagree
I like to drive fast.
1 strongly agree
2 agree
3 neither agree nor disagree
4 disagree
5 strongly disagree

For the following statements, a response of 1 indicates right brained; a response of 2 indicates right brained (not as strongly); a response of 5 indicates the opposite of right brained; a response of 4 indicates the opposite of right brained (not as strongly); a response of 3 is neutral.
I am a good speller.
1 strongly disagree
2 disagree
3 neither agree nor disagree
4 agree
5 strongly agree
I am an organized person.
1 strongly disagree
2 disagree
3 neither agree nor disagree
4 agree
5 strongly agree
I am able to tell approximately how much time has passed without looking at my watch.
1 strongly disagree
2 disagree
3 neither agree nor disagree
4 agree
5 strongly agree

For the following statement, a response of 1 indicates thriftiness; a response of 2 indicates thriftiness (not as strongly); a response of 5 indicates the opposite of thriftiness; a response of 4 indicates the opposite of thriftiness (not as strongly); a response of 3 is neutral.
I purchase a daily newspaper.
1 strongly disagree
2 disagree
3 neither agree nor disagree
4 agree
5 strongly agree

Scoring: Responses to the statements and questions are converted to numerical values, and nine numerical scores, one for each of the nine personality traits, are determined by summing these numerical values. The three “directness”, “guardedness”, and “right brained” scores are combined into a 3-dimensional vector. The remaining six scores (“risk taking”, “thriftiness”, “artistic/imaginative”, “optimism”, “night person”, and “absent mindedness”) are combined into a 6-dimensional vector.

For agents, the 3-dimensional and 6-dimensional vectors are stored in a database. For clients, the 3-dimensional and 6-dimensional vectors are used to find matching agents.

Once an agent completes the questions in the Dimension pages 120, the Agent profile is added to the matching system database 130, with an initial status of active, and a page opens containing information along the lines of the following:
Agent's Thank You Page:
   Done!
   Your profile has been added to our database. You will be contacted via email each time a client selects you as the agent they would love to work with.

Once a client completes the questions in the Dimension pages (220), a page opens containing information along the lines of the following:
Client's Thank You Page/Find Agents Page:
   Find An Agent You'll Love Working With
   Select Province/Territory (from drop down list)
   Select City (from drop down list or auto complete)
   Click Here To Activate Dimension 3 And Select From Agents You'll Love Working With (230)

If a client indicates a desire to find an agent (240), the Ranking & Matching process is initiated.

Ranking & Matching: The client's 3-dimensional and 6-dimensional score vectors are determined as described above. In addition, the client's “guardedness” score is examined separately to categorize the client as either “guarded” or “not guarded”.

The plurality of agents stored in the database (which may be filtered based on some conditions, such as the client's geographical location preferences (250), for example) are broken into two groups, based on their “guardedness” score (260). The guardedness score is examined separately to make this categorization, in the same way the score was examined for the client.

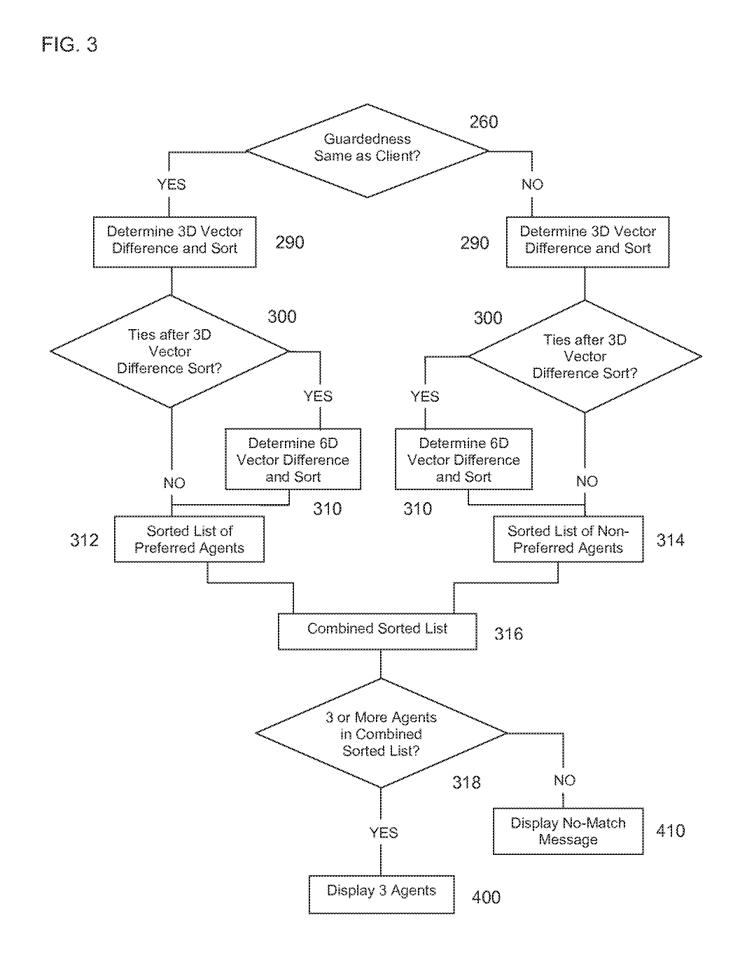

As illustrated in FIG. 3, the first group of agents (the preferred group 270) matches the “guardedness” of the client, while the second group (the non-preferred group 280) does not. For example, if the client is found to be “not guarded”, the preferred group of agents consist of all “not guarded” agents, while the other group of agents will consist of all “guarded” agents.

For each agent in the preferred group, the 3-dimensional client vector is compared with the 3-dimensional agent vector. The magnitude of the difference between the client and preferred group agent vectors is used to rank and sort the agents; the smaller the magnitude of the difference vector, the better the match and the higher the ranking. The preferred group agents are ranked by the magnitude of their difference vector, and sorted in ascending order of this rank (290). If there are any ties in the preferred group agent rankings based on the magnitude of the difference between the client and preferred group agent 3-dimensional vectors (300), the 6-dimensional client vector is compared against the 6-dimensional preferred group agent vector. The magnitude of the difference between the client and preferred group agent 6 vectors is used to break the ties; the smaller the magnitude of the (6-dimensional) difference vector, the better the match. Any such-tied preferred group agents are ranked by the magnitude of their (6-dimensional) difference vector, and sorted in ascending order of this rank (310). In this way, a sorted list of preferred agents 312 is prepared.

For each agent in the non-preferred group, the 3-dimensional client vector is compared with the 3-dimensional agent vector. The magnitude of the difference between the client and non-preferred group agent vectors is used to raml and sort the agents; the smaller the magnitude of the difference vector, the better the match and the higher the ranking. The non-preferred group agents are ranked by the magnitude of their difference vector, and sorted in ascending order of this rank (290). If there are any ties in the non-preferred group agent rankings based on the magnitude of the difference between the client and non-preferred group agent 3-dimensional vectors (300), the 6-dimensional client vector is compared against the 6-dimensional non-preferred group agent vector. The magnitude of the difference between the client and non-preferred group agent 6 vectors is used to break the ties; the smaller the magnitude of the (6-dimensional) difference vector, the better the match. Any such-tied non-preferred group agents are ranked by the magnitude of their (6-dimensional) difference vector, and sorted in ascending order of this rank (310). In this way, a sorted list of non-preferred agents (314) is prepared.

The sorted list of preferred agents (312) is combined with the sorted list of non-preferred agents (314) to provide a combined sorted list (316), in which the preferred agents are followed by the non-preferred agents, that is, all of the preferred agents are ranked higher than any of the non-preferred agents.

The system is preferably configured to present at least three agents to the client. The system determines (318) whether three or more agents are present in the combined sorted list (316). If three or more agents are present in the combined sorted list (316), the three top-ranked agents are displayed to the client (400). If three or more agents are not present in the combined sorted list (316), to reduce the likelihood of making a poor or inappropriate recommendation, no agents are presented to the client and instead a no-match message is displayed (410).

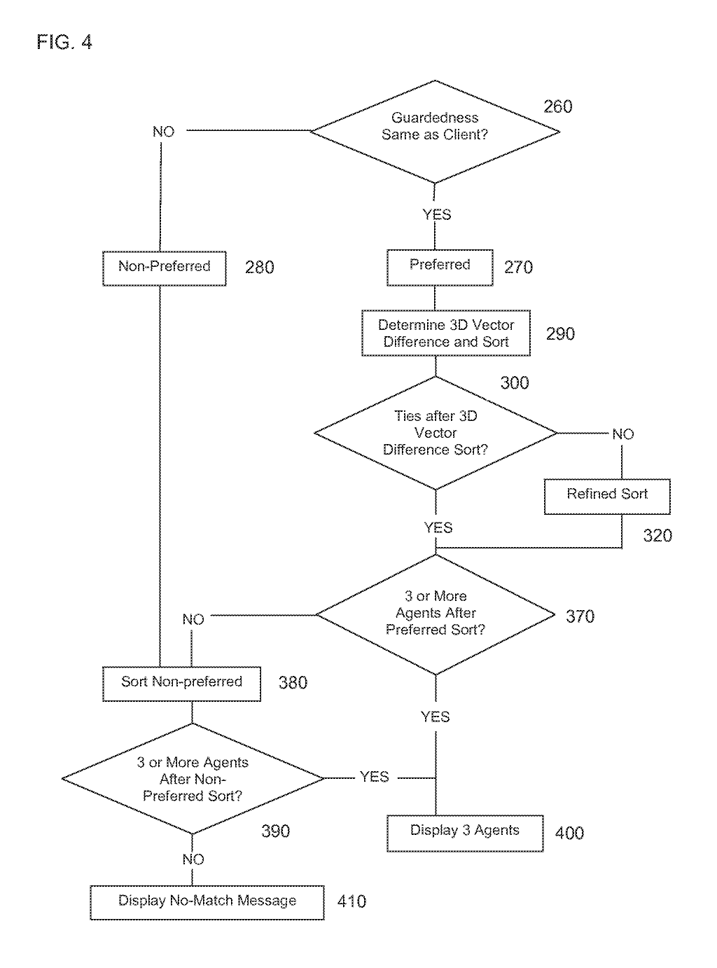

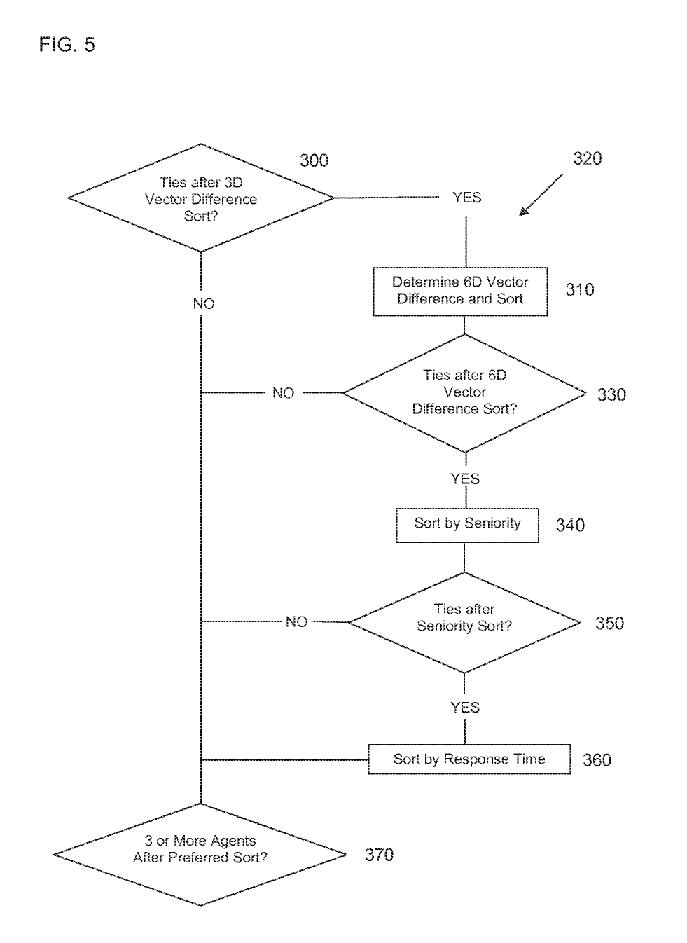

An alternative approach to the steps between determining whether each agent's guardedness is the same as the client 260 (and the identification of each agent as either preferred or non-preferred), and either displaying 3 agents 400 or displaying a no-match message 410, is illustrated in FIGS. 4 and 5.

For each agent in the preferred group, the 3-dimensional client vector is compared with the 3-dimensional agent vector. The magnitude of the difference between the client and agent vectors is used to rank and sort the agents; the smaller the magnitude of the difference vector, the better the match. The preferred group agents are ranked by the magnitude of their difference vector, and sorted in ascending order of this rank (290).

If there are any ties in the preferred group agent rankings based on the magnitude of the difference between the client and agent 3-dimensional vectors (300), a refined sort (320) (shown expanded in FIG. 5) is used to resolve the ties. If any agents have exactly the same ranking, the 6-dimensional client vector is compared against the 6-dimensional agent vector. The magnitude of the difference between the client and agent 6 vectors is used to break the ties; the smaller the magnitude of the 6-dimensional difference vector, the better the match. Any tied agents are ranked by the magnitude of their 6-dimensional difference vector, and sorted in ascending order of this rank (310). Other factors are used to decide any remaining ties. If there is a tie after the 6-dimensional difference vector sort (330), then the tied agents are sorted by seniority of membership, that is, the date and time of agent sign up is used to decide any ties (340). If there are any ties after the seniority sort (350), then the tied agents are sorted by response time (360) (discussed below).

It is then determined whether 3 or more agents are present in the preferred agent list (370). If not, the non-preferred agents are ranked in exactly the same way as the preferred agents (380) and the sorted non-preferred agents are combined with the sorted preferred agents, such that the preferred agents are followed by the non-preferred agents, that is, all of the preferred agents are ranked higher than any of the non-preferred agents.

The system is preferably configured to present at least three agents to the client. The system determines (390) whether three or more agents are present after the non-preferred sort and list combination. If three or more agents are present, the three top-ranked agents are displayed to the client (400). If three or more agents are not present, to reduce the likelihood of making a poor or inappropriate recommendation, no agents are presented to the client and instead a no-match message is displayed (410)

The results from the Ranking & Matching process are displayed to the client in a Client's Search Results Page preferably configured generally along the lines of the following:
Client's Search Results Page:
   Agent 1—display photo, first name, and compatibility score
   “Contact (agent's first name)” button
   Agent 2—display photo, first name, and compatibility score
   “Contact (agent's first name)” button
   Agent 3—display photo, first name, and compatibility score
   “Contact (agent's first name)” button
   “View next 3 agents” button

Once the client hits a “Contact” button (420), a pop up window advising that an email has been sent to the agent and reading in part something along the lines of the following, “Please allow 24 hours for email confirmation that (agent's first name) is available to work with you.”

The matching system contemplates a guided initial communication email flow between the client and agent to ensure that contact is successfully made and to record same.

Once the client hits a “Contact” button, an email is sent to the selected agent (430) advising that there is a client who wishes to work with them. The agent has 24 hrs to either accept or decline, via an accept or decline email link. If no response is received within 12 hours (440), a reminder e-mail is sent to the agent (450).

The matching system records the length of time taken for an agent to respond (460), and, as indicated above, may use agent response time as a factor in deciding ties in agent rankings

The agent account for an agent that fails to respond within 24 hours (460) is treated as dormant or suspended (470) (see below).

In the event of timely acceptance by the agent (500): the client is emailed a congratulations note along with the full contact details of the agent; the agent is emailed a congratulations note with full contact details of the client, as well as an auto generated PDF referral agreement form attached, and responsibilities to honour the agreement; the receiving agent's broker is also sent an email with the PDF referral agreement attached, which outlines the broker's responsibility to ensure the referral agreement is submitted and honoured by the agent (520).

The Auto Generated PDF Referral Agreement Contains:
the contact information for the matching system operator
the operator's associated brokerage's full Information
the agent's full information from the agent sign up page
the agents brokerage's full information from agent sign up page
the client's full contact information from client sign up page
the Referral Agreement handling and processing instructions

In the event that the agent declines within 24 hours: the agent is sent an email thanking them for their consideration (the agent's matching system profile remains active and in good standing); the client is sent an email with a link to take them back to the “Find Agent's” page and advised to log back in to their account and reselect.

In the event of a dormant agent account: the agent is sent an email advising that their profile has been temporarily suspended until they login to reactivate their account (a login link is provided in the email); the client is sent an email with a link to take them back to the “Find Agent's” page and advised to log back in to their account and reselect (480).

Four months after a matching and introduction of agent and client, the client is sent an email (490) with a short survey to rate their experience and determine if a deal was ever or is soon to be completed. Also a request to write a testimonial, and appropriate links to do so are provided in the email.

The scope of the claims should not be limited by the preferred embodiments set forth in the examples, but should be given the broadest interpretation consistent with the description as a whole.

What is claimed is:

1. A web-based method for matching agents or advisors with potential clients, implemented via a programmable computer or plurality of programmable computers connected to the internet and configured to present a website and perform the processes required to perform the following steps:
collecting and storing business, contact and personality profile information from a plurality of agents or advisors;
collecting and storing contact and personality profile information from potential clients;
on receiving a request for agent compatibility information from a potential client, ranking the agents or advisors in terms of personality compatibility with the potential client;
presenting compatibility information and partial identity information about one or more agents or advisors to the potential client;
on receiving a request for agent contact from a potential client, notifying an agent or advisor selected by the potential client from the presented agents or advisors, of the agent's or advisor's selection; and
on receiving an acceptance response from the agent or advisor selected by the potential client, providing the potential client and the selected agent or advisor with each other's contact information.

2. The method of claim 1 wherein the agents or advisors are real estate agents and further comprising the step of pre-selecting agents satisfying a geographic preference, prior to the step of ranking the agents or advisors in terms of personality compatibility with the potential client.

3. The method of claim 1 wherein the step of ranking the agents or advisors in terms of personality compatibility with the potential client, comprises determining the guardedness of the client and the agents or advisors, and identifying the agents or advisors who have the same guardedness as the client as preferred and the agents or advisors who do not share the same guardedness as the client as non-preferred.

4. The method of claim 3, wherein the step of ranking the agents or advisors in terms of personality compatibility with the potential client, further comprises determining a 3-dimensional vector based on scores for directness, guardedness, and right brained, for each of the client and the preferred agents or advisors; determining the magnitude of the difference between the 3-dimensional vectors for the client and the preferred agents or advisors; and ranking each of the preferred agents or advisors in terms of compatibility with the client based on the magnitude of the difference between the 3-dimensional vectors wherein the smaller the difference the higher the compatibility ranking.

5. The method of claim 4, further comprising determining whether ranking each of the preferred agents or advisors in terms of compatibility with the client based on the magnitude of the difference between the 3-dimensional vectors has produced a tie, that is, an equal ranking for any preferred agents or advisors; and, if there is a tie: determining a 6-dimensional vector based on scores for risk taking, thriftiness, artistic/imaginative, optimism, night person and absent mindedness, for each of the client and the tied preferred agents or advisors; determining the magnitude of the difference between the 6-dimensional vectors for the client and the tied preferred agents or advisors; and ranking each of the tied preferred agents or advisors relative to each other in terms of compatibility with the client based on the magnitude of the difference between the 6-dimensional vectors wherein the smaller the difference the higher the compatibility ranking.

6. The method of claim 5, further comprising determining whether the ranking of each of the tied agents or advisors relative to each other in terms of compatibility with the client based on the magnitude of the difference between the 6-dimensional vectors has eliminated all ties; and, if not, determining the duration of time since each of the tied preferred agents or advisors provided the agent's or advisor's personality profile information; and ranking each of the tied agents or advisors relative to each other in terms of the duration of time wherein the greater the duration of time, the higher the ranking.

7. The method of claim 6, further comprising determining whether the ranking of each of the tied agents or advisors relative to each other in terms the duration of time since each of the tied preferred agents or advisors provided the agent's or advisor's personality profile information has eliminated all ties; and, if not, determining a response time value for the tied preferred agents or advisors, and ranking each of the tied agents or advisors relative to each other in terms of their response time values wherein the smaller the response time values the higher the ranking.

8. The method of claim 5, further comprising determining whether the ranking of each of the tied agents or advisors relative to each other in terms of compatibility with the client based on the magnitude of the difference between the 6-dimensional vectors has eliminated all ties; and, if not, determining a response time value for the tied preferred agents or advisors, and ranking each of the tied agents or advisors relative to each other in terms of their response time values wherein the smaller the response time values the higher the ranking.

9. The method of claim 4, further comprising determining whether there are three or more preferred agents or advisors; and if not, determining a 3-dimensional vector based on scores for directness, guardedness, and right brained, for each of the non-preferred agents or advisors; determining the magnitude of the difference between the 3-dimensional vectors for the client and the non-preferred agents or advisors; and ranking each of the non-preferred agents or advisors in terms of compatibility with the client based on the magnitude of the difference between the 3-dimensional vectors wherein the smaller the difference the higher the compatibility ranking, and wherein all non-preferred agents or advisors are ranked below any preferred agents or advisors.

10. The method of claim 9, further comprising determining whether ranking each of the non-preferred agents or advisors in terms of compatibility with the client based on the magnitude of the difference between the 3-dimensional vectors has produced a tie, that is, an equal ranking for any non-preferred agents or advisors; and, if there is a tie: determining a 6-dimensional vector based on scores for risk taking, thriftiness, artistic/imaginative, optimism, night person and absent mindedness, for each of the tied non-preferred agents or advisors; determining the magnitude of the difference between the 6-dimensional vectors for the client and the tied non-preferred agents or advisors; and ranking each of the tied non-preferred agents or advisors relative to each other in terms of compatibility with the client based on the magnitude of the difference between the 6-dimensional vectors wherein the smaller the difference the higher the compatibility ranking.

11. The method of claim 1, wherein presenting compatibility information and partial identity information about one or more agents or advisors to the potential client, comprises presenting, for each of said agents or advisors, a compatibility ranking, a photograph and a first name.

12. The method of claim 1 wherein notifying an agent or advisor selected by the potential client from the presented agents or advisors, of the agent's or advisor's selection, comprises sending a selection email to the agent or advisor.

13. The method of claim 12, further comprising determining whether receiving an acceptance response from the agent or advisor occurs within 12 hours of sending the selection e-mail to the agent or advisor; and, if not, sending a reminder email to the agent or advisor.

14. The method of claim 12, further comprising determining whether receiving an acceptance response from the agent or advisor occurs within 24 hours of sending the selection e-mail to the agent or advisor; and, if not, recording a status of dormant for the agent or advisor; sending a dormant-notification email to the agent or advisor notifying the agent or advisor of the dormant status; and sending an email to the potential client inviting the potential client to select another agent or advisor.

15. A web-based method for matching real estate agents with potential clients, implemented via a programmable computer or plurality of programmable computers connected to the internet and configured to present a website and perform the processes required to perform the following steps:
collecting and storing business, contact and personality profile information from a plurality of real estate agents;
collecting and storing contact and personality profile information from potential clients;
on receiving a request for agent compatibility information from a potential client: pre-selecting agents satisfying a geographic preference and then ranking the pre-selected agents in terms of personality compatibility with the potential client, wherein the ranking comprises:
determining the guardedness of the client and the agents, and identifying the agents who have the same guardedness as the client as preferred and the agents who do not share the same guardedness as the client as non-preferred;
determining a 3-dimensional vector based on scores for directness, guardedness, and right brained, for each of the client and the preferred agents, determining the magnitude of the difference between the 3-dimensional vectors for the client and the preferred agents, ranking each of the preferred agents in terms of compatibility with the client based on the magnitude of the difference between the 3-dimensional vectors wherein the smaller the difference the higher the compatibility ranking
determining whether ranking each of the preferred agents in terms of compatibility with the client based on the magnitude of the difference between the 3-dimensional vectors has produced a tie, that is, an equal ranking for any preferred agents, and, if there is a tie: determining a 6-dimensional vector based on scores for risk taking, thriftiness, artistic/imaginative, optimism, night person and absent mindedness, for each of the client and the tied preferred agents; determining the magnitude of the difference between the 6-dimensional vectors for the client and the tied preferred agents; and ranking each of the tied preferred agents relative to each other in terms of compatibility with the client based on the magnitude of the difference between the 6-dimensional vectors wherein the smaller the difference the higher the compatibility ranking;
determining a 3-dimensional vector based on scores for directness, guardedness, and right brained, for each of the client and the non-preferred agents, determining the magnitude of the difference between the 3-dimensional vectors for the client and the non-preferred agents, ranking each of the non-preferred agents in terms of compatibility with the client based on the magnitude of the difference between the 3-dimensional vectors wherein the smaller the difference the higher the compatibility ranking
determining whether ranking each of the non-preferred agents in terms of compatibility with the client based on the magnitude of the difference between the 3-dimensional vectors has produced a tie, that is, an equal ranking for any non-preferred agents, and, if there is a tie: determining a 6-dimensional vector based on scores for risk taking, thriftiness, artistic/imaginative, optimism, night person and absent mindedness, for each of the client and the tied non-preferred agents; determining the magnitude of the difference between the 6-dimensional vectors for the client and the tied non-preferred agents; and ranking each of the tied non-preferred agents relative to each other in terms of compatibility with the client based on the magnitude of the difference between the 6-dimensional vectors wherein the smaller the difference the higher the compatibility ranking;
combining the ranked preferred agents and ranked non-preferred agents into a single ranked list in which all of the preferred agents are ranked higher than any of the non-preferred agents;
determining whether there are three or more agents in the single ranked list, and, if so, presenting compatibility information and partial identity information for the three top-ranked agents to the potential client;
on receiving a request for agent contact from a potential client, notifying an agent selected by the potential client from the presented agents, of the agent's selection; and
on receiving an acceptance response from the agent selected by the potential client, providing the potential client and the selected agent with each other's contact information.
